(19) United States
(12) Patent Application Publication
(10) Pub. No.: US 2008/0197774 A1
(43) Pub. Date: Aug. 21, 2008

(54) Plasma display panel and method of fabricating the same

(76) Inventor: Young-gil Yoo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/071,344

(22) Filed: Feb. 20, 2008

(30) Foreign Application Priority Data
Feb. 21, 2007 (KR) 10-2007-17502

(51) Int. Cl. H01J 17/49; H01J 9/02

(52) U.S. Cl. 313/582; 445/24

(57) ABSTRACT

A plasma display panel (PDP), includes first and second substrates facing each other, a plurality of first and second electrodes along a first direction between the first and second substrates, a plurality of third electrodes along a second direction between the first and second substrates, barrier ribs between the first and second substrates, the barrier ribs defining a plurality of pixels and exhaust areas between the pixels, and photoluminescent layers, the photoluminescent layers being in the pixels, on the barrier ribs, and in the exhaust areas.

### BACKGROUND OF THE INVENTION

1. Field of the Invention

Embodiments of the present invention relate to a plasma display panel (PDP) and a method of fabricating the same. More specifically, embodiments of the present invention relate to a PDP with increased bright room contrast and a method of fabricating the same.

2. Description of the Related Art

A PDP may refer to a flat panel display capable of forming images by a gas discharge phenomenon. Such displays may implement larger and thinner screens than, e.g., cathode ray tube (CRT) displays, and may exhibit improved display properties, e.g., wide viewing angles, high brightness, and so forth.

The conventional PDP may include a plurality of electrodes and barrier ribs between two facing substrates. The barrier ribs may define a plurality of pixels, so application of voltage to the pixels via the electrodes may trigger emission of light from the pixels.

The substrates of the conventional PDP, however, may be transparent, so external light may be directly incident on elements between the substrates, e.g., the barrier ribs. Light incident on elements between the substrates may be transmitted therethrough and/or reflected therefrom, and thereby cause interference with light emitted from the pixels. For example, external light incident on the conventional barrier ribs may be transmitted or reflected from the barrier ribs to interfere with light emitted from the pixels, so a contrast ratio of the conventional PDP may be lowered.

### SUMMARY OF THE INVENTION

Embodiments of the present invention are therefore directed to a PDP and a method of fabricating the same, which substantially overcome one or more of the disadvantages and shortcomings of the related art.

It is therefore a feature of an embodiment of the present invention to provide a PDP having a substrate with an increased dark portion and capable of enhancing bright room contrast.

It is therefore another feature of an embodiment of the present invention to provide a method of fabricating a PDP having a substrate with an increased dark portion and capable of enhancing bright room contrast.

At least one of the above and other features and advantages of the present invention may be realized by providing a PDP including first and second substrates facing each other, a plurality of first and second electrodes along a first direction between the first and second substrates, a plurality of third electrodes along a second direction between the first and second substrates, barrier ribs between the first and second substrates, the barrier ribs defining a plurality of pixels and exhaust areas between the pixels, and photoluminescent layers, the photoluminescent layers being in the pixels, on the barrier ribs, and in the exhaust areas.

The photoluminescent layers may include red, green, and blue phosphors. The photoluminescent layers on the barrier ribs and in the exhaust areas may include a mixture of at least two of the red, green, and blue phosphors. The photoluminescent layers on barrier ribs between sub-pixels emitting red and green lights may include a mixture of red and green phosphors. The photoluminescent layers on barrier ribs between sub-pixels emitting blue and green lights may include a mixture of blue and green phosphors. The photoluminescent layers on barrier ribs between sub-pixels emitting red and blue lights may include a mixture of red and blue phosphors. The photoluminescent layers in the exhaust areas may include a mixture of the red and blue phosphors. The PDP may further include at least one dielectric layer between the first and second substrates. A portion of the exhaust area may surround each pixel.

At least one of the above and other features and advantages of the present invention may be also realized by providing a method of fabricating a PDP, including forming first and second substrates to face each other, forming a plurality of first and second electrodes along a first direction between the first and second substrates, forming a plurality of third electrodes along a second direction between the first and second substrates, forming barrier ribs between the first and second substrates, such that the barrier ribs define a plurality of pixels and exhaust areas between the pixels, and forming photoluminescent layers in the pixels, on the barrier ribs, and in the exhaust areas.

Forming the photoluminescent layers may include using a dispense method. Using the dispense method may include a continuous deposition along the PDP. Forming the photoluminescent layers may include depositing red, green, and blue phosphors. Forming the photoluminescent layers may include depositing a mixture of at least two of the red, green, and blue phosphors on the barrier ribs and in the exhaust areas. Forming the photoluminescent layers may include a subtractive mixing method. Forming the first and second electrodes may include depositing a transparent conductive film on the first substrate. The method may further include patterning the transparent film. The method may further include forming a dielectric layer on the first and second electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a perspective exploded view of a PDP according to an embodiment of the present invention;

FIG. 2 illustrates a partial plan view of pixels in the PDP of FIG. 1; and

FIG. 3 illustrates a perspective view of a method of fabricating a PDP according to an embodiment of the present invention.

### DETAILED DESCRIPTION OF THE INVENTION

Korean Patent Application No. 10-2007-0017502, filed on Feb. 21, 2007, in the Korean Intellectual Property Office, and entitled: “Plasma Display Panel and Fabricating Method Thereof,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer, element, or substrate, it can be directly on the other layer, element, or substrate, or intervening layers or elements may also be present. In addition, it will also be understood that when a layer or element is referred to as being “between” two layers or elements, it can be the only layer or element between the two layers or elements, or one or more intervening layers or elements may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of:” For example, the expression “at least one of A, B, and C” may also include an nth member, where n is greater than 3, whereas the expression “at least one selected from the group consisting of A, B, and C” does not.

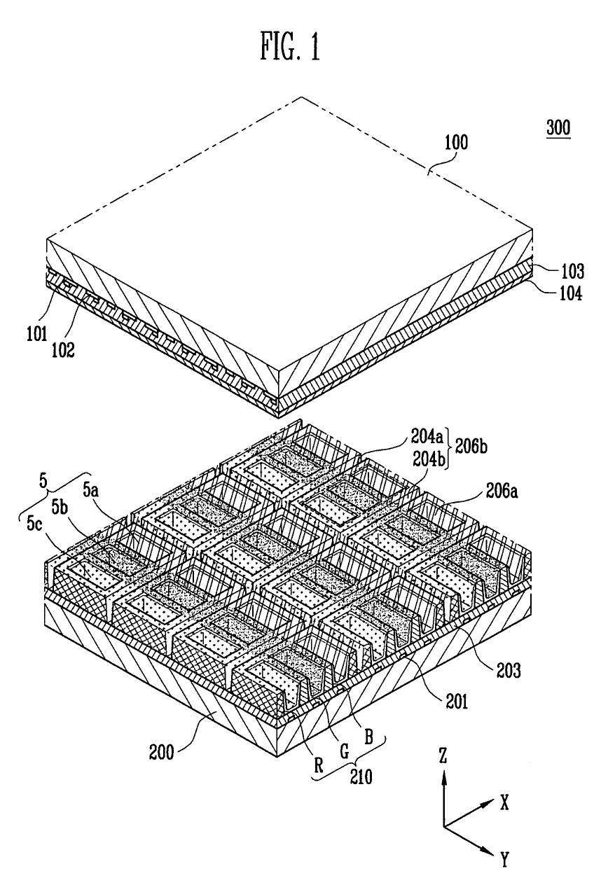

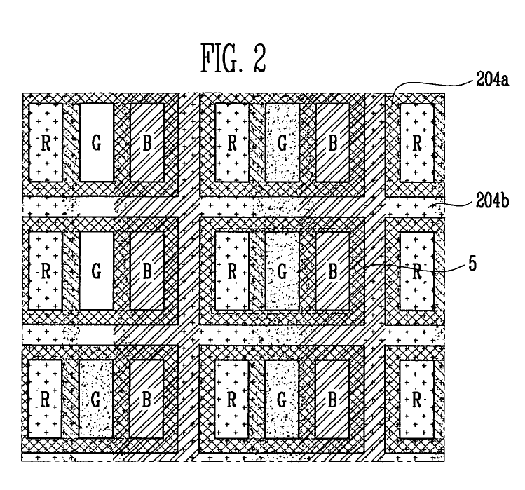

FIGS. 1-2 illustrate perspective and plan views, respectively, of a PDP 300 according to an embodiment of the present invention. The PDP 300 in FIGS. 1-2 is an AC type three-electrode surface discharge PDP. It is noted, however, that other types of PDPs, e.g., DC-type PDPs, facing structure PDPs, and so forth, are within the scope of the present invention.

Referring to FIGS. 1-2, the PDP 300 may include front and rear substrates 100 and 200, a plurality of scan and sustain electrodes 101 and 102, a front dielectric layer 103, a protective film 104, a plurality of address electrodes 201, a rear dielectric layer 203, barrier ribs 204a, and photoluminescent layers 210.

The front and rear substrates 100 and 200 of the PDP 300 may be spaced apart and may face one another. The front and rear substrates 100 and 200 may be formed of any suitable material, e.g., a transparent glass material. The transparent glass material may include one or more of lead oxide (PbO), silicon oxide (SiO₂), and/or boron oxide (B₂O₃).

The scan and sustain electrodes 101 and 102 of the PDP 300 may be on the front substrate 100 along a first direction, e.g., along the x-axis, and may be parallel to one another. The scan and sustain electrodes 101 and 102 may be arranged in an alternating pattern and may include bus electrodes. The scan and sustain electrodes 101 and 102 may be formed of any suitable material, e.g., a metal film exhibiting high conductivity. Examples of metal films exhibiting high conductivity may include one or more of silver (Ag), gold (Au), copper (Cu), and so forth. The scan and sustain electrodes 101 and 102 may also be formed of a transparent conductive material.

The front dielectric layer 103 of the PDP 300 may be formed on the front substrate 100 and may face the rear substrate 200. More specifically, the front dielectric layer 103 may be formed to cover the scan and sustain electrodes 101 and 102, so capacitance may be formed to control current in the scan and sustain electrodes 101 and 102. Further, the front dielectric layer 103 may protect the scan and sustain electrodes 101 and 102 from charged particles during discharge, and thereby increase lifetime of the scan and sustain electrodes 101 and 102. The front dielectric layer 103 may be formed of any suitable dielectric material, e.g., one or more of PbO, B₂O₃, SiO₂, and so forth.

The protective layer 104 of the PDP 300 may be formed on the dielectric layer 103 and may face the rear substrate 200. Accordingly, the protective layer 104 may cover the front dielectric layer 103 to prevent or substantially minimize damage thereto due to impact of charged particles during discharge. Additionally, the protective layer 104 may allow discharge of secondary electrons. The protective layer 104 may be formed of any suitable material, e.g., magnesium oxide (MgO).

The address electrodes 201 of the PDP 300 may be formed on the rear substrate 200 along a second direction, e.g., along the y-axis. The address electrodes 201 may be formed of a transparent conductive material, e.g., indium-tin-oxide (ITO), and/or of an opaque conductive material, e.g., Ag, Au, and Cu, and so forth.

The rear dielectric layer 203 of the PDP 300 may be formed on the rear substrate 200 and may face the front substrate 100. More specifically, the rear dielectric layer 203 may be formed to cover the address electrodes 201, so capacitance may be formed to control current in the address electrodes 201. Further, the rear dielectric layer 203 may protect the address electrodes 201 from impact with charged particles during discharge, and thereby increase lifetime of the address electrodes 201. The rear dielectric layer 203 may be formed of any suitable dielectric material, e.g., one or more of PbO, B₂O₃, SiO₂, and so forth.

The barrier ribs 204a of the PDP 300 may be between the front and rear substrates 100 and 200, e.g., on the rear substrate 200, and may divide a space between the front and rear substrates 100 and 200 into a discharge area 206a and a non-discharge area 206b. More specifically, the barrier ribs 204a may be arranged in any suitable configuration to define a plurality of pixels 5 and exhaust areas 204b therebetween. Further, the barrier ribs 204a may define sub-pixels 5a-5c within the pixels 5, e.g., sub-pixel 5a may be separated from sub-pixel 5b by a portion of the barrier ribs 204a. As illustrated in FIGS. 1-2, the barrier ribs 204a may have a closed configuration defining a plurality of pixels 5, i.e., a plurality of clusters containing sub-pixels 5a-5c, arranged in a matrix form. The sub-pixels 5a, 5b, and 5c of the pixels 5 may emit blue (B), green (G), and red (R) light, respectively, and may define the discharge area 206a, e.g., a plurality of discharge cells emitting light to form a predetermined image. The pixels 5 may be driven by an active matrix method, i.e., each pixel 5 may be driven via a separate active element, or by a passive matrix method, i.e., each pixel 5 may be driven by applying voltage to an electrode.

Each pixel 5 defined by the barrier ribs 204a may be surrounded by the exhaust areas 204b, so every two pixels 5 may be separated from each other by a respective exhaust area 204b, as illustrated in FIGS. 1-2. Accordingly, leakage of light from one pixel 5 to another may be substantially minimized. The exhaust areas 204b may form flow paths to exhaust gas from the PDP, e.g., remove impurities before sealing the front and rear substrates 101 and 102, and/or to fill a discharge gas, e.g., one or more of neon (Ne), xenon (Xe), and so forth, in the discharge area 206a. The exhaust areas 204b and the barrier ribs 204a may define the non-discharge area 206b, i.e., a region of the PDP 300 not forming images.

The photoluminescent layers 210 of the PDP 300 may be on the rear substrate 200. More specifically, the photoluminescent layers 210 may be on the entire rear substrate 200 to overlap both the discharge area 206a and the non-discharge area 206b. Accordingly, the photoluminescent layers 210 may be in the pixels 5, on the barrier ribs 204a, and in the exhaust areas 204b.

More specifically, the photoluminescent layers 210 may include, e.g., red (R), green (G), and/or blue (B) phosphor layers, so R, G, and B phosphor layers may be deposited in the pixels 5, on the barrier ribs 204a, and in the exhaust areas 204b. The R, G, and B phosphor layers may have a different configuration in the discharge and non-discharge areas 206a and 206b. In particular, in the discharge area 206a, each of the R, G, and B phosphor layers may be deposited in a respective sub-pixel 5c, sub-pixel 5b, and sub-pixel 5a of each pixel 5, so each sub-pixel 5a-5c of each pixel 5 may include only a single color of the photoluminescent layers 210. Accordingly, each sub-pixels 5a-5c of each pixel 5 may emit a different color, so light emitted from the discharge area 206a, i.e., a region defined by the plurality of sub-pixels 5a-5c, may form images.

The R, G, and B phosphor layers in the non-discharge area 206b, i.e., on the barrier ribs 204a and in the exhaust area 204b, may be mixed. More specifically, at least two of the R, G, and B phosphor layers may be deposited on each of the barrier ribs 204a and the exhaust area 204b. For example, a portion of the non-discharge area 206b located between the red sub-pixel R and green sub-pixel G, i.e., a portion of a barrier rib 204a between the 5c and 5b sub-pixels, may include both R and G phosphor layers, as illustrated in FIGS. 1-2. Similarly, a portion of the non-discharge area 206b between the green sub-pixel G and the blue sub-pixel B may include both G and B phosphor layers. Some portions of the non-discharge area 206b may include all the R, G, and B phosphor layers.

Mixing at least two of the R, G, and B phosphor layers in the non-discharge area 206b may provide a phosphor layer exhibiting a darker color than any of the R, G, and/or B phosphor layers alone. Therefore, the non-discharge area 206b of the PDP 300 may provide a substantially dark or opaque region, e.g., a phosphor layer exhibiting a black color. For example, the exhaust areas 204b in the non-discharge area 206b may include R and B phosphor layers, as illustrated in FIG. 2, and may absorb any light incident thereon. Further, the exhaust area 204b may absorb any external light incident from an exterior of the PDP 300 or any light reflected from either of the sub-pixels 5a, 5b, and/or 5c in pixels 5. As such, the non-discharge-area 206b of the PDP 300 may have increased absorbance of light, and thereby substantially minimize light reflection toward an exterior of the PDP 300, which in turn, may improve bright room contrast of the PDP 300.

The PDP 300 may be formed as follows. The front and rear substrates 100 and 200 may be obtained and cleaned. A conductive film may be formed on each of the front and rear substrates 100 and 200, followed by patterning, e.g., a pattern printing method, an electrode film formation, and/or a photolithography, the conductive film to form scan and sustain electrodes 101 and 102 on the front substrate 100 and address electrodes 201 on the rear substrate 200. The front and rear dielectric layers 103 and 203 may be formed on the front and rear substrates 100 and 200, respectively, and the protective film 104 may be deposited on the front dielectric layer 103. The barrier ribs 204a may be formed on the rear dielectric layer 203 to define the pixels 5 and the exhaust areas 204b.

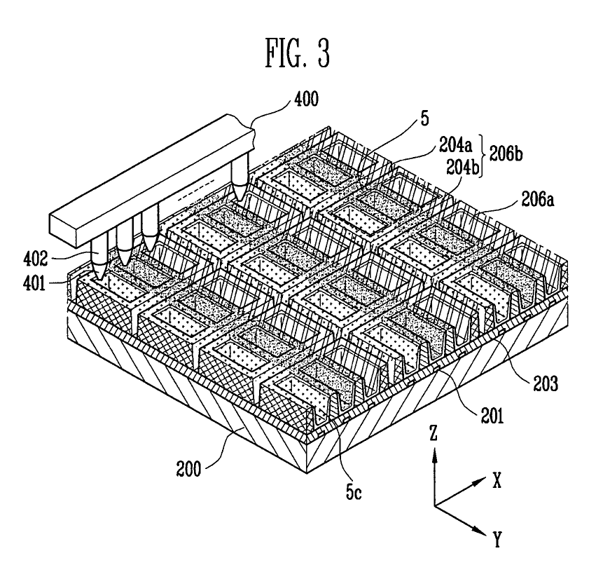

The photoluminescent layers 210 may be disposed on the rear substrate 200 by a dispense method. The dispense method refers to a method simultaneously applying each of the phosphors R, G, and B to the rear substrate 200. For example, as illustrated in FIG. 3, a dispenser 400 including a plurality of outlets 401 with corresponding nozzles 402 arranged in equal intervals may be positioned above the barrier ribs 204a. The dispenser 400 may be moved continuously along a predetermined direction to dispose the photoluminescent layers 210, so the phosphors B, G, and R may be formed in the respective sub-pixels 5a-5c, and in the non-discharge area 206b. The dispenser 400 may be adjusted, e.g., one or more of the intervals of the outlets 401, deposition rate, and so froth, so the photoluminescent layers 210 in the non-discharge area 206b may have a dark color formed via a subtractive mixture of at least two of the phosphors R, G, and B. The subtractive mixture refers to a mixing method of colors, where mixing a first color with a second color provides a third color having a lower brightness, i.e., darker color, than either of the first and second colors. The R, G, and B phosphor layers may be mixed along one direction, e.g., along the x-axis, so color deposited along, e.g., the y-axis, may be substantially uniform. For example, an array of sub-pixels 5c arranged along the y-axis and adjacent to each other may have a same color.

Once the photoluminescent layers 210 are deposited, sealing materials may be applied to edges of the front and rear substrates 100 and 200, followed by aligning and sealing the first and second substrates 100 and 200 with the barrier ribs 204a, address electrodes 201, scan electrodes 101, and sustain electrodes 102 therebetween.

Embodiments of the PDP according to the present invention may be advantageous in providing an exhaust area between pixels to prevent or substantially minimize optical interference therebetween. Further, the PDP may include photoluminescent materials both in the discharge and non-discharge areas, so the non-discharge area may have a dark color to substantially minimize reflection of visible light. Accordingly, it is possible to raise the light room contrast of the PDP.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
first and second substrates facing each other;
a plurality of first and second electrodes along a first direction between the first and second substrates;
a plurality of third electrodes along a second direction between the first and second substrates;
barrier ribs between the first and second substrates, the barrier ribs defining a plurality of pixels and exhaust areas between the pixels; and
photoluminescent layers, the photoluminescent layers being in the pixels, on the barrier ribs, and in the exhaust areas.

2. The PDP as claimed in claim 1, wherein the photoluminescent layers include red, green, and blue phosphors.

3. The PDP as claimed in claim 2, wherein the photoluminescent layers on the barrier ribs and in the exhaust areas include a mixture of at least two of the red, green, and blue phosphors.

4. The PDP as claimed in claim 3, wherein the photoluminescent layers on barrier ribs between sub-pixels emitting red and green lights include a mixture of red and green phosphors.

5. The PDP as claimed in claim 3, wherein the photoluminescent layers on barrier ribs between sub-pixels emitting blue and green lights include a mixture of blue and green phosphors.

6. The PDP as claimed in claim 3, wherein the photoluminescent layers in the exhaust areas include a mixture of red and blue phosphors.

7. The PDP as claimed in claim 1, further comprising at least one dielectric layer between the first and second substrates.

8. The PDP as claimed in claim 1, wherein each pixel is surrounded by exhaust areas.

9. A method of fabricating a plasma display panel (PDP), comprising:
forming first and second substrates to face each other;
forming a plurality of first and second electrodes along a first direction between the first and second substrates;
forming a plurality of third electrodes along a second direction between the first and second substrates;
forming barrier ribs between the first and second substrates, such that the barrier ribs define a plurality of pixels and exhaust areas between the pixels; and
forming photoluminescent layers in the pixels, on the barrier ribs, and in the exhaust areas.

10. The method as claimed in claim 9, wherein forming the photoluminescent layers includes using a dispense method.

11. The method as claimed in claim 10, wherein using the dispense method includes a continuous deposition along the PDP.

12. The method as claimed in claim 10, wherein forming the photoluminescent layers includes depositing red, green, and blue phosphors.

13. The method as claimed in claim 12, wherein forming the photoluminescent layers includes depositing a mixture of at least two of the red, green, and blue phosphors on the barrier ribs and in the exhaust areas.

14. The method as claimed in claim 13, wherein forming the photoluminescent layers includes a subtractive mixing method.

15. The method as claimed in claim 9, wherein forming the first and second electrodes includes depositing a transparent conductive film on the first substrate.

16. The method as claimed in claim 15, further comprising patterning the transparent film.

17. The method as claimed in claim 9, further comprising forming a dielectric layer on the first and second electrodes.
